(19) United States
(12) Patent Application Publication
(10) Pub. No.: US 2026/0321939 A1
(43) Pub. Date: Oct. 15, 2026

(54) Hopper Device for Secondary Battery and Method of Injecting Electrolyte Into Secondary Battery Using Same

(71) Applicant: SK On Co., Ltd., Seoul (KR)

(72) Inventor: Seung Hyeon CHEON, Daejeon (KR)

(21) Appl. No.: 19/545,136

(22) Filed: Feb. 20, 2026

(30) Foreign Application Priority Data
Feb. 24, 2025 (KR) 10-2025-0023804

(51) Int. Cl. H01M 50/618; H01M 10/44; H01M 10/52; H01M 50/60; H01M 50/673

(52) U.S. Cl. CPC H01M 50/618; H01M 10/446; H01M 10/52; H01M 50/668; H01M 50/673

(57) ABSTRACT

A hopper device for a secondary battery is proposed. The hopper device includes a hopper body configured to inject an electrolyte into an interior of a secondary battery, and a storage tank in fluid communication with an interior of the hopper body and configured to store the electrolyte therein. A method of injecting an electrolyte into a secondary battery is provided.

### CROSS REFERENCE TO RELATED APPLICATION

The present application claims priority to Korean Patent Applications No. 10-2025-0023804, filed Feb. 24, 2025, the entire contents of which are incorporated herein for all purposes by this reference.

### BACKGROUND

### Technical Field

The present disclosure relates to a hopper device for a secondary battery and a method of injecting an electrolyte into a secondary battery using the same.

### Description of the Related Art

Generally, a secondary battery is a battery that may be rechargeable through a discharge process in which chemical energy is converted into electrical energy and a charge process in which electrical energy is converted into chemical energy.

Secondary batteries may include nickel-cadmium (Ni-Cd) batteries, nickel-metal hydride (Ni-MH) batteries, lithium-metal batteries, lithium-ion (Li-ion) batteries, lithium-ion (Li-ion) polymer batteries, and the like.

Among secondary batteries, lithium secondary batteries have a cycle life of about 500 cycles or more and a short charging time of about 1 to 2 hours, and may be about 30% to 40% lighter than a nickel-metal hydride battery, thereby enabling weight reduction. In addition, among existing secondary batteries, the lithium secondary batteries may have the highest voltage per unit cell and excellent energy density, and thus may have characteristics optimized for mobile devices.

### SUMMARY

Accordingly, the present disclosure has been made keeping in mind the above problems occurring in the related art, and an objective of the present disclosure is to provide an apparatus and method for manufacturing a secondary battery, which may enable a secondary electrolyte injection process to be continuously performed after pre-charge.

Another objective of the present disclosure is to provide an apparatus and method for manufacturing a secondary battery, which may be widely applied to green-technology fields using batteries, such as electric vehicles, battery charging stations, and other applications including photovoltaic power generation and wind power generation.

According to an aspect of the present disclosure, a hopper device for a secondary battery includes: a hopper body configured to inject an electrolyte into an interior of a secondary battery; and a storage tank in fluid communication with an interior of the hopper body and configured to store the electrolyte therein.

The hopper device may include a vacuum pump in fluid communication with the interior of the hopper body to create a vacuum atmosphere in the interior of the hopper body and the interior of the secondary battery.

The hopper device may include a transfer line configured to guide movement of the electrolyte between the hopper body and the storage tank.

The transfer line may include a pressure controller in fluid communication with an external environment.

The pressure controller may include a backflow prevention trap configured to block discharge of the electrolyte to the external environment.

The hopper device may include an electrolyte supply source configured to supply the electrolyte to the storage tank.

The hopper body may include a flow meter configured to measure an amount of the electrolyte injected into the interior of the secondary battery.

According to another aspect of the present disclosure, a method of injecting an electrolyte into a secondary battery includes: a vacuum stage of creating a vacuum atmosphere in an interior of the secondary battery; a supply stage of supplying the electrolyte; and an injection stage of upon completion of the vacuum stage and the supply stage, injecting the electrolyte supplied in the supply stage into the interior of the secondary battery.

The vacuum stage may include creating the vacuum atmosphere in the interior of the secondary battery using a vacuum pump of a hopper device for a secondary battery, the supply stage may include supplying the electrolyte from an electrolyte supply source to a storage tank of the hopper device, and the injection stage may include injecting the electrolyte stored in the storage tank into the interior of the secondary battery through a hopper body of the hopper device.

The method may include, prior to the vacuum stage, a pre-charge stage of pre-charging the secondary battery and removing, to the hopper device, gas generated during the pre-charging process, wherein the pre-charge stage may include creating the vacuum atmosphere in the secondary battery using the hopper device, and the vacuum stage may include keeping the hopper device connected to the secondary battery contiguously from the pre-charge stage.

In the vacuum stage and the supply stage, fluid communication between the storage tank and the secondary battery may be blocked.

The vacuum stage may include connecting the vacuum pump and the interior of the secondary battery in fluid communication manner, the supply stage may include connecting the electrolyte supply source and the storage tank in fluid communication manner and an interior of the storage tank and an external environment in fluid communication manner, and the injection stage may include blocking the fluid communication between the vacuum pump and the interior of the secondary battery, the fluid communication between the electrolyte supply source and the storage tank, and the fluid communication between the interior of the storage tank and the external environment.

The method may include, after the injection stage, a secondary vacuum stage of upon an amount of the electrolyte injected into the interior of the secondary battery being insufficient, blocking the fluid communication between the interior of the secondary battery and the storage tank and then connecting the interior of the secondary battery and the vacuum pump in fluid communication manner to create a vacuum atmosphere in the interior of the secondary battery.

The method may include, after the secondary vacuum stage, a secondary injection stage of blocking the fluid communication between the interior of the secondary battery and the vacuum pump, and connecting the interior of the secondary battery and the storage tank in fluid communication manner to inject the electrolyte stored in the storage tank into the interior of the secondary battery.

The vacuum stage and the supply stage may be performed simultaneously.

The features and advantages of the present disclosure will become more apparent from the following detailed description with reference to the accompanying drawings.

Prior to this, terms and words used in the present specification and claims shall not be interpreted in a conventional or dictionary sense. Based on the principle that an inventor may properly define terms to best describe his/her invention, the terms and words shall be construed in the meaning and concept consistent with the technical spirit of the present disclosure.

According to an embodiment of the present disclosure, the secondary batteries may be manufactured in reduced manufacturing costs.

According to an embodiment of the present disclosure, secondary-battery manufacturing equipment may be minimized and capital expenditures for equipment investment may be reduced.

### BRIEF DESCRIPTION OF THE DRAWINGS

The above and other objectives, features and advantages of the present disclosure will be more clearly understood from the following detailed description when taken in conjunction with the accompanying drawings, in which:

FIG. 1 is a schematic diagram illustrating a hopper device for a secondary battery according to an embodiment of the present disclosure;

FIG. 2 is a diagram illustrating the use state of the hopper device of FIG. 1 connected to a secondary battery;

FIG. 3 is a flowchart illustrating a method of injecting an electrolyte into a secondary battery according to an embodiment of the present disclosure; and

FIG. 4 is a diagram illustrating an electrolyte injection system for a secondary battery according to an embodiment of the present disclosure.

### DETAILED DESCRIPTION

The terminology used herein to describe an embodiment of the present disclosure is not intended to limit the present disclosure. As used herein, the singular forms are intended to include the plural forms as well, unless the context clearly indicates otherwise.

In assigning reference numerals to components in the drawings, like components, even if shown in different drawings, are given like reference numerals wherever possible, and similar components are given similar reference numerals.

The drawings may be shown schematically or exaggerated for purposes of describing embodiments. As used herein, expressions such as “have,” “may have,” “include,” or “may include” indicate the presence of a stated feature (e.g., a numeral, function, operation, or component) and do not preclude the presence of one or more additional features.

Terms such as “one,” “other,” “another,” “first,” “second,” etc. are used to distinguish one component from another component, and do not limit the component by the terms.

Hereinafter, an embodiment of the present disclosure will be described in detail with reference to the accompanying drawings.

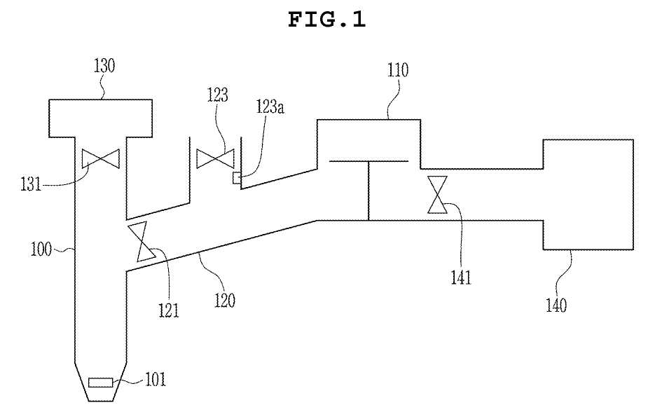

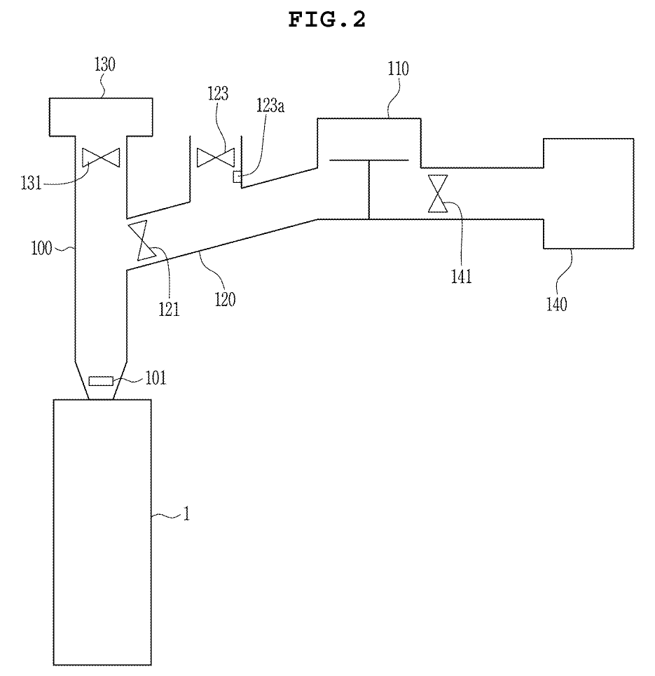

FIG. 1 is a schematic diagram illustrating a hopper device for a secondary battery according to an embodiment of the present disclosure, and FIG. 2 is a diagram illustrating the use state of the hopper device of FIG. 1 connected to a secondary battery.

Referring to FIGS. 1 and 2, the hopper device for a secondary battery according to an embodiment of the present disclosure may include a hopper body 100 configured to inject an electrolyte into an interior of a secondary battery 1, and a storage tank 110 connected with an interior of the hopper body 100 in fluid communication manner and configured to store the electrolyte therein.

In the present disclosure, the secondary battery may be any one of a prismatic secondary battery, a cylindrical secondary battery, and a pouch-type secondary battery.

A prismatic secondary battery may require a relatively high effective injection amount of electrolyte.

Accordingly, in a prismatic secondary-battery manufacturing process, a required amount of electrolyte may not be sufficiently injected with only a primary electrolyte injection process, and thus a secondary injection process may be performed.

In addition, the hopper device for a secondary battery of the present disclosure may perform pre-charge after the primary electrolyte injection in the prismatic secondary-battery manufacturing process and may then perform a secondary electrolyte injection.

That is, the hopper device for a secondary battery of the present disclosure may be connected to the secondary battery 1 during the pre-charge process and may remove, in real time, gases generated during the pre-charge process through vacuum.

Further, after completion of the pre-charge process, without removing the hopper device for a secondary battery of the present disclosure, the secondary battery 1 may be continuously vacuumed and the secondary electrolyte injection may be performed.

The hopper body 100 may be connected to an electrolyte injection port of the secondary battery 1 to provide a flow path that guides the electrolyte into the interior of the secondary battery.

The hopper body 100 may include a tubular body with an electrolyte flow path formed therein.

Further, the hopper body 100 may have one open side (lower side), which may be in fluid communication with an injection port provided in the secondary battery 1.

Further, the hopper body 100 may be connected, at a peripheral portion thereof, with a transfer line 120 for introducing the electrolyte in fluid communication manner.

Further, the hopper body 100 may guide the electrolyte flowing along an interior of the transfer line 120 into the interior of the secondary battery 1 through an internal flow path thereof.

Further, the hopper body 100 may include a flow meter 101 configured to measure an amount of the electrolyte injected into the interior of the secondary battery 1.

The flow meter 101 may measure the amount of the electrolyte injected from the hopper body 100 into the secondary battery 1 and may transmit an electrical signal to a controller (not illustrated).

Further, the hopper body 100 may be connected in fluid communication manner with a vacuum pump 130 configured to create a vacuum atmosphere in the interior of the secondary battery 1.

The vacuum pump 130 may be connected in fluid communication manner with the interior of the hopper body 100 and may be in fluid communication with the interior of the secondary battery 1 through the hopper body 100, thereby creating a vacuum atmosphere in the interior of the hopper body 100 and the interior of the secondary battery 1.

The vacuum pump 130 may be connected to one side of the hopper body 100 to be in fluid communication with the interior of the hopper body 100.

Further, the vacuum pump 130 may include a vacuum valve 131 configured to open and close a portion connected to the hopper body 100.

The vacuum valve 131 may be operated by the controller to open and close a connection between the vacuum pump 130 and the hopper body 100.

When the vacuum valve 131 is opened, the vacuum pump 130 and the hopper body 100 may be connected.

Conversely, when the vacuum valve 131 is closed, connection between the vacuum pump 130 and the hopper body 100 may be blocked.

The storage tank 110 may store therein an electrolyte to be injected into the secondary battery 1.

The storage tank 110 may be connected in fluid communication manner with the transfer line 120 and may be in fluid communication with the interior of the hopper body 100 through the transfer line 120.

That is, the storage tank 110 may allow the electrolyte stored therein to flow into the interior of the hopper body 100 through the transfer line 120.

The storage tank 110 may be connected in fluid communication manner with an electrolyte supply source 140 for supplying the electrolyte to the storage tank 110.

The electrolyte supply source 140 may receive the electrolyte from the outside and may supply the electrolyte into the interior of the storage tank 110.

The electrolyte supply source 140 may be a device capable of supplying the electrolyte to the storage tank 110, such as an electrolyte dispenser.

A supply valve 141 may be provided to open and close a flow path between the storage tank 110 and the electrolyte supply source 140.

The supply valve 141 may be operated by the controller to open and close the flow path between the storage tank 110 and the electrolyte supply source 140.

When the supply valve 141 is opened, the storage tank 110 and the electrolyte supply source 140 may be connected.

Conversely, when the supply valve 141 is closed, connection between the storage tank 110 and the electrolyte supply source 140 may be blocked.

The transfer line 120 may guide movement of the electrolyte between the hopper body 100 and the storage tank 110.

The transfer line 120 may be provided between the storage tank 110 and the hopper body 100.

As illustrated in FIGS. 1 and 2, the transfer line 120 may be provided to be inclined downward so as to extend downward from the storage tank 110 toward the hopper body 100.

Accordingly, the transfer line 120 may allow the electrolyte to freely fall from the storage tank 110 toward the hopper body 100, thereby inducing smooth movement of the electrolyte.

The transfer line 120 may include a line valve 121 configured to open and close between the storage tank 110 and the hopper body 100.

The line valve 121 may be operated by the controller to open and close a connection between the storage tank 110 and the hopper body 100.

When the line valve 121 is opened, the storage tank 110 and the hopper body 100 may be connected.

Conversely, when the line valve 121 is closed, connection between the storage tank 110 and the hopper body 100 may be blocked.

Further, the transfer line 120 may include a pressure controller 123 configured to be in fluid communication with an external environment.

The pressure controller 123 may bring an interior of the storage tank 110 into fluid communication with an external atmosphere in order to control an internal pressure of the storage tank 110.

The pressure controller 123 may be operated by the controller to open or close, thereby controlling the internal pressure of the storage tank 110.

When the pressure controller 123 is opened, the storage tank 110 and the outside may be connected.

Conversely, when the pressure control unit 123 is closed, connection between the storage tank 110 and the outside may be blocked.

In a process of supplying the electrolyte to the storage tank 110 or other process, when the internal pressure of the storage tank 110 increases, the pressure controller 123 may be opened to connect the storage tank 110 with the outside, thereby reducing the internal pressure of the storage tank 110 until the internal pressure becomes equal to atmospheric pressure.

The pressure controller 123 may include a backflow prevention trap 123a configured to prevent leakage of the electrolyte to the outside.

The backflow prevention trap 123a may block the electrolyte from leaking to the outside through the pressure controller 123.

That is, when the pressure controller 123 is opened, the backflow prevention trap 123a may prevent the electrolyte from being discharged to the pressure controller 123.

The backflow prevention trap 123a may include, for example, a level sensor configured to detect a level of the electrolyte.

Further, the backflow prevention trap 123a may transmit, to the controller, an electrical signal detected by the level sensor.

Further, when the controller determines, based on the electrical signal transmitted from the backflow prevention trap 123a, that the electrolyte level is higher than a preset level, the controller may close the pressure controller 123.

Hereinafter, a method of injecting an electrolyte into a secondary battery according to the present disclosure will be described in detail with reference to the drawings.

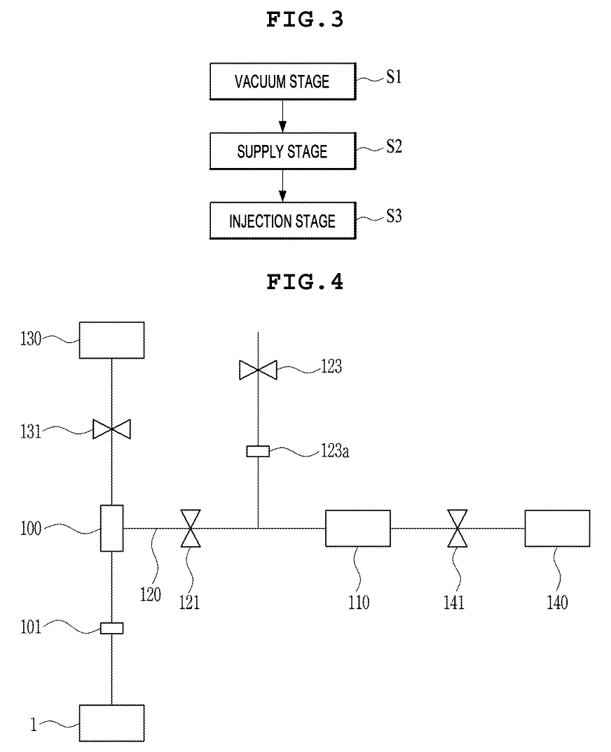

FIG. 3 is a flowchart illustrating a method of injecting an electrolyte into a secondary battery according to an embodiment of the present disclosure, and FIG. 4 is a diagram illustrating an electrolyte injection system for a secondary battery according to an embodiment of the present disclosure.

Referring to FIGS. 3 and 4, the electrolyte injection method according to an embodiment of the present disclosure may include a vacuum stage S1 of creating a vacuum atmosphere in an interior of a secondary battery 1, a supply stage S2 of supplying an electrolyte, and an injection stage S3 of upon completion of the vacuum stage S1 and the supply stage S2, injecting the electrolyte supplied in the supply stage S2 into the interior of the secondary battery 1.

The electrolyte injection method according to an embodiment of the present disclosure may relate to an electrolyte injection method in which, in a manufacturing process of a secondary battery 1, after a primary electrolyte injection into the interior of the secondary battery 1, a pre-charge process is performed, and then a secondary electrolyte injection is performed to supplement an effective electrolyte injection amount of the secondary battery 1.

The electrolyte injection method according to an embodiment of the present disclosure may include, prior to the vacuum stage S1, a pre-charge stage of pre-charging the secondary battery 1 after the primary electrolyte injection and removing, to the hopper device for a secondary battery, gases generated during the pre-charge process.

In the pre-charge stage, gases generated during the pre-charge process may be removed to the outside in a state in which the secondary battery 1 is brought into a vacuum atmosphere using the vacuum pump 130 of the hopper device for a secondary battery.

In the pre-charge stage, a degree of vacuum in the interior of the secondary battery 1 may be maintained at -80 kPa to -90 kPa.

The vacuum stage S1 may be a stage of creating a vacuum atmosphere in the interior of the secondary battery 1 using the vacuum pump 130 of the hopper device for a secondary battery that remains continuously connected to the secondary battery 1 without removing the hopper device for a secondary battery that has been connected to the secondary battery 1 to inject the electrolyte into the interior of the secondary battery 1 in the pre-charge stage, as a stage following the pre-charge stage.

Accordingly, in the vacuum stage S1, the vacuum valve 131 may be opened to bring the vacuum pump 130 into fluid communication with the interior of the secondary battery 1.

Such a vacuum stage S1 may allow a secondary electrolyte injection to be performed immediately into the interior of the secondary battery 1 without process downtime after completion of the pre-charge stage.

That is, in the vacuum stage S1, the interior of the secondary battery 1 may be brought into a vacuum atmosphere using the vacuum pump 130 of the hopper device for a secondary battery in order to perform the secondary electrolyte injection into the interior of the secondary battery 1.

In the vacuum stage S1, a degree of vacuum in the interior of the secondary battery 1 may be maintained at -80 kPa to -90 kPa.

The supply stage S2 may be a stage of opening the supply valve 141 and supplying the electrolyte from the electrolyte supply source 140 of the hopper device for a secondary battery to the storage tank 110 in order to store, in the storage tank 110, the electrolyte to be injected into the interior of the secondary battery 1.

The supply stage S2 may be performed simultaneously with the vacuum stage S1.

Accordingly, in the vacuum stage S1 and the supply stage S2, the line valve 121 may be closed to block connection between the storage tank 110 and the hopper body 100, thereby blocking fluid communication between the storage tank 110 and the secondary battery 1.

Further, in the supply stage S2, the electrolyte supply source 140 and the storage tank 110 may be brought into fluid communication, and the interior of the storage tank 110 may be brought into fluid communication with the outside.

To this end, in the supply stage S2, the supply valve 141 and the pressure controller 123 may be opened while the line valve 121 remains closed.

In the supply stage S2, in a process of supplying the electrolyte to the storage tank 110, the pressure controller 123 may be opened to reduce the internal pressure of the storage tank 110 to outside atmospheric pressure, thereby preventing an increase in the internal pressure of the storage tank 110.

Further, in the supply stage S2, the level of the electrolyte may be detected by the backflow prevention trap 123a, and when the electrolyte level is higher than a preset level in the controller, the controller may close the pressure controller 123, thereby preventing leakage of the electrolyte to the outside.

The injection stage S3 may be a stage of injecting, into the interior of the secondary battery 1 through the hopper body 100 of the hopper device for a secondary battery, the electrolyte stored in the storage tank 110 to supplement an effective electrolyte injection amount of the secondary battery 1.

In the injection stage S3, the vacuum valve 131 may be closed to block fluid communication between the vacuum pump 130 and the interior of the secondary battery 1.

Further, in the injection stage S3, the supply valve 141 may be closed to block fluid communication between the electrolyte supply source 140 and the storage tank 110.

Further, in the injection stage S3, the pressure controller 123 may be closed to block fluid communication between the interior of the storage tank 110 and the outside.

Further, in the injection stage S3, the line valve 121 may be opened to inject the electrolyte stored in the storage tank 110 into the interior of the secondary battery 1.

Further, in the injection stage S3, the amount of the electrolyte injected from the hopper body 100 into the interior of the secondary battery 1 may be measured using the flow meter 101, and an electrical signal may be transmitted to the controller.

The electrolyte injection method according to an embodiment of the present disclosure may include, as a stage subsequent to the injection stage S3, a secondary vacuum stage.

In the secondary vacuum stage, when the controller determines, by analyzing the electrical signal received from the flow meter 101, that an amount of the electrolyte injected into the interior of the secondary battery 1 is less than a preset injection amount, the line valve 121 may be closed to block fluid communication between the interior of the secondary battery 1 and the storage tank 110, and then the vacuum valve 131 may be opened to bring the interior of the secondary battery 1 into fluid communication with the vacuum pump 130.

Further, in the secondary vacuum stage, the interior of the secondary battery 1 may be brought into a vacuum atmosphere using the vacuum pump 130.

In the secondary vacuum stage, a degree of vacuum in the interior of the secondary battery 1 may be set to -80 kPa to -90 kPa.

The electrolyte injection method according to an embodiment of the present disclosure may include, as a stage subsequent to the secondary vacuum stage, a secondary injection stage.

In the secondary injection stage, the vacuum valve 131 may be closed to block fluid communication between the interior of the secondary battery 1 and the vacuum pump 130.

Further, in the secondary injection stage, the line valve 121 may be opened to bring the interior of the secondary battery 1 into fluid communication with the storage tank 110, and while the supply valve 141 remains closed, the pressure controller 123 may be closed, and the electrolyte stored in the storage tank 110 may be injected into the interior of the secondary battery 1.

After completion of electrolyte injection into the secondary battery 1, the hopper device for a secondary battery may be separated from the secondary battery 1 while the vacuum valve 131, the line valve 121, the supply valve 141, and the pressure control unit 123 remain closed.

The present disclosure has been described in detail through specific embodiments. The embodiments are provided to describe the present disclosure in detail, and the present disclosure is merely illustrative and does not limit the appended claims. It is apparent to those skilled in the art that various changes and modifications to the embodiments are possible within the scope and spirit of the present disclosure, and such variations and modifications are intended to fall within the scope of the appended claims.

What is claimed is:

1. A hopper device for a secondary battery, the hopper device comprising:
a hopper body configured to inject an electrolyte into an interior of a secondary battery; and
a storage tank in fluid communication with an interior of the hopper body and configured to store the electrolyte therein.

2. The hopper device of claim 1, further comprising:
a vacuum pump in fluid communication with the interior of the hopper body to create a vacuum atmosphere in the interior of the hopper body and the interior of the secondary battery.

3. The hopper device of claim 1, further comprising:
a transfer line configured to guide movement of the electrolyte between the hopper body and the storage tank.

4. The hopper device of claim 3, wherein the transfer line includes a pressure controller in fluid communication with an external environment.

5. The hopper device of claim 4, wherein the pressure controller includes a backflow prevention trap configured to block discharge of the electrolyte to the external environment.

6. The hopper device of claim 1, further comprising:
an electrolyte supply source configured to supply the electrolyte to the storage tank.

7. The hopper device of claim 1, wherein the hopper body includes a flow meter configured to measure an amount of the electrolyte injected into the interior of the secondary battery.

8. A method of injecting an electrolyte into a secondary battery, the method comprising:
a vacuum stage of creating a vacuum atmosphere in an interior of the secondary battery;
a supply stage of supplying the electrolyte; and
an injection stage of upon completion of the vacuum stage and the supply stage, injecting the electrolyte supplied in the supply stage into the interior of the secondary battery.

9. The method of claim 8, wherein the vacuum stage comprises creating the vacuum atmosphere in the interior of the secondary battery using a vacuum pump of a hopper device for a secondary battery,
the supply stage comprises supplying the electrolyte from an electrolyte supply source to a storage tank of the hopper device, and
the injection stage comprises injecting the electrolyte stored in the storage tank into the interior of the secondary battery through a hopper body of the hopper device.

10. The method of claim 9, further comprising:
prior to the vacuum stage, a pre-charge stage of pre-charging the secondary battery and removing, to the hopper device, gas generated during the pre-charging process,
wherein the pre-charge stage comprises creating the vacuum atmosphere in the secondary battery using the hopper device, and
the vacuum stage comprises keeping the hopper device connected to the secondary battery contiguously from the pre-charge stage.

11. The method of claim 9, wherein in the vacuum stage and the supply stage, fluid communication between the storage tank and the secondary battery is blocked.

12. The method of claim 11, wherein the vacuum stage comprises connecting the vacuum pump and the interior of the secondary battery in fluid communication manner,
the supply stage comprises connecting the electrolyte supply source and the storage tank in fluid communication manner and an interior of the storage tank and an external environment in fluid communication manner, and
the injection stage comprises blocking the fluid communication between the vacuum pump and the interior of the secondary battery, the fluid communication between the electrolyte supply source and the storage tank, and the fluid communication between the interior of the storage tank and the external environment.

13. The method of claim 12, further comprising:
after the injection stage, a secondary vacuum stage of upon an amount of the electrolyte injected into the interior of the secondary battery being insufficient, blocking the fluid communication between the interior of the secondary battery and the storage tank and then connecting the interior of the secondary battery and the vacuum pump in fluid communication manner to create a vacuum atmosphere in the interior of the secondary battery.

14. The method of claim 13, further comprising:
after the secondary vacuum stage, a secondary injection stage of blocking the fluid communication between the interior of the secondary battery and the vacuum pump, and connecting the interior of the secondary battery and the storage tank in fluid communication manner to inject the electrolyte stored in the storage tank into the interior of the secondary battery.

15. The method of claim 8, wherein the vacuum stage and the supply stage are performed simultaneously.
